(19) United States
(12) Patent Application Publication
(10) Pub. No.: US 2024/0013320 A1
(43) Pub. Date: Jan. 11, 2024

(54) GRANT BILLING SYSTEM AND METHODS OF USE

(71) Applicant: Edge Grant Billing Systems Inc., Laguna Niguel, CA (US)

(72) Inventor: David Weaver, Laguna Niguel, CA (US)

(73) Assignee: Edge Grant Billing Systems Inc., Laguna Niguel, CA (US)

(21) Appl. No.: 18/348,673

(22) Filed: Jul. 7, 2023

Related U.S. Application Data
(60) Provisional application No. 63/359,927, filed on Jul. 11, 2022.

(51) Int. Cl. G06Q 40/12; G06Q 20/14

(52) U.S. Cl. CPC G06Q 40/125; G06Q 20/14

(57) ABSTRACT

A method for allocating funds includes (A) accessing, by one or more computers, one or more electronic databases comprising (1) aggregated program information for one or more programs having a total grant amount, a self-funded amount, and a total amount equal to a sum of the total grant amount and the self-funded amount, (2) aggregated grant information for one or more grants, each of the of the one or more grants including a billing cycle, a total budget, an amount spent and a remaining balance, (3) a relationship between each of the one or more programs to each of the one or more grants, (B) obtaining, by the one or more computers, expense transaction data from a general ledger, and (C) allocating, by the one or more computers, the expense transaction data to the one or more programs and the one or more grants according to a predetermined allocation method.

### CROSS-REFERENCE TO RELATED APPLICATIONS

The present application claims priority to U.S. Provisional Application Ser. No. 63/359,927, filed Jul. 11, 2022, the content of which is hereby incorporated by reference in its entirety as if fully set forth herein.

### FIELD OF THE DISCLOSURE

The present disclosure generally relates to a grant billing system, and more specifically to a grant billing system that allocates costs across multiple grant contracts.

### BACKGROUND

Managing grant funding and expenses for non-profit organizations can be a complex and time-consuming task. Existing solutions often involve manual calculations, multiple systems, and the potential for errors and inefficiencies. There is a need for a comprehensive software application that automates grant billing processes, ensures accurate expense allocation, handles budget modifications, and provides real-time reporting and analysis.

To do these calculations and manage them going forward requires many hours of the monthly accounting lifecycle and is error-prone with many points of failure. Additionally, the ability to identify if a grant needs a budget modification (course correction) is severely hampered by the manual process which leads to last minute fire drills to avoid having Unspent Funds. Many factors play into this, such as personnel limited skill sets, burnout and/or staff turnover.

### SUMMARY

A method for allocating funds among a plurality of program and one or more grants includes (A) accessing, by one or more computers, one or more electronic databases comprising (1) aggregated program information for one or more programs, each of the one or more programs including a total grant amount, a self-funded amount, and a total amount equal to a sum of the total grant amount and the self-funded amount, (2) aggregated grant information for one or more grants, each of the of the one or more grants including a billing cycle, a total budget, an amount spent and a remaining balance, (3) a relationship between each of the one or more programs to each of the one or more grants, (B) obtaining, by the one or more computers, expense transaction data from a general ledger, and (C) allocating, by the one or more computers, the expense transaction data to the one or more programs and the one or more grants according to a predetermined allocation method.

### BRIEF DESCRIPTION OF THE DRAWINGS

Various embodiments of the presently disclosed treatment devices are disclosed herein with reference to the drawings, wherein:

FIG. 1A illustrates a computer system upon which an embodiment may be implemented;

FIG. 1B illustrate a method of allocating expenses according to one embodiment;

FIG. 2 is a screenshot showing initial logging into the platform;

FIG. 3 is a screenshot showing a billing system dashboard view;

FIG. 4 is a screenshot showing a billing system program level overview;

FIG. 5 is a screenshot showing a billing system grant level overview;

FIGS. 6A-D are screenshots showing billing system importing of a general ledger file;

FIG. 7A is a screenshot showing a billing system company setup;

FIG. 7B is a screenshot showing a billing system affiliate setup;

FIG. 8 is a screenshot showing a billing system grant setup;

FIG. 9 is a screenshot showing instructions for document management setup; and

FIGS. 10A-B are screenshots showing report generation and reporting naming conventions.

Various embodiments of the present disclosure will now be described with reference to the appended drawings. It is to be appreciated that these drawings depict only some embodiments of the disclosure and are therefore not to be considered limiting of its scope.

### DETAILED DESCRIPTION

Despite the various improvements that have been made to billing systems, conventional methods suffer from some shortcomings.

There therefore is a need for further improvements to the devices, systems, and methods of processing and managing multiple gran contracts. Among other advantages, the present disclosure may address one or more of these needs.

In the following description, for the purpose of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other and does not imply an ordering, timing, or any other characteristic of the referenced items unless otherwise specified; the terms “such as”, “e.g.”, for example”, and the like describe one or more examples but are not limited to the described example/s; the terms “comprises” and/or “comprising” specify the presence of stated features, but do not preclude the presence or addition of one or more other features.

A “computer system” refers to one or more computers, such as one or more physical computers, virtual computers, and/or computing devices. As an example, a computer system may be, or may include, one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to a “computer system” herein may mean one or more computers, unless expressly stated otherwise. When a computer system performs an action, the action is performed by one or more computers of the computer system.

A “client” refers to a combination of integrated software components and an allocation of computational resources, such as memory, a computing device, and processes on a computing device for executing the integrated software components. The combination of the software and computational resources are configured to interact with one or more servers over a network, such as the Internet. A client may refer to either the combination of components on one or more computers, or the one or more computers.

A “server” (also referred to as “server system” or “server computer system”) refers to a combination of integrated software components and an allocation of computational resources, such as memory, a computing device, and processes on the computing device for executing the integrated software components. The combination of the software and computational resources provide a particular type of function on behalf of clients of the server. A server may refer to either the combination of components on one or more computers, or the one or more computers. A server may include multiple servers; that is, a server may include a first server computing device and a second server computing device, which may provide the same or different functionality to the same or different set of clients.

### General Overview

In some embodiments, a grant billing system includes a cloud-based application with a unique business process design that automates the billing and management for any not-for-profit organization that receives one or more grant awards from the government (e.g., federal, state and local governments), and/or private foundations.

The grant billing system may automate the expense allocation calculations of any eligible expense across multiple grant contracts at the expense categories and may be directed to stay within the amount limits of the of any grant contract. The grant billing system may also manage any grant contract budget modification that impact the eligible expense amounts of a particular the expense category. The grant billing system may also include a modeling function that handles financial “what-if” scenarios around grant funding and provides management reports that are downloadable into Excel and/or PDF format.

The benefits of the disclosed grant billing system are numerous. For example, the grant billing system may provide the ability, across all grants/programs, to manage a budget and to manage the funding obligations from government and/or private grants to ensure that all funds are properly utilized within the proscribed time limits. The platform may be fully scalable, so that organizations can pursue and obtain additional grants without the worry of the added work related to grant billing and reporting, leading to significant cost savings. In some examples, the grant billing system may empower Not-For-Profit organizations to get a complete overview of where they are at the grant/program funding level at any given time. Providing transparency, “a single pane of glass” to view all grant balances and allocations. An engine of allocation rules may take into account complex factors to calculate grant expense allocations based on a simple uploaded general ledger file.

By utilizing cloud-based data architecture, organization can virtually manage their grant budget allocations. With centralized grant records and reports, a single, shared source of truth is available. This leads to a more holistic approach that collectively takes into consideration all grants, programs and expenses. Using this process, the billing process is expedited and the number of hours looking for data are decreased. Accuracy and efficiency may be increased. Modeling functions may perform helpful “What if” scenarios. The impact of a budget modification (e.g., an increased expense) can quickly assessed over multiple grants. Finally, a quick-view dashboard may be presented to the user to quickly assess certain criteria, conditions and/or milestones.

### Implementation Mechanisms—Hardware Overview

According to one embodiment, the techniques described herein are implemented by one or more special-purpose computing devices. The special-purpose computing devices may be hard-wired to perform one or more techniques described herein, including combinations thereof. Alternatively, and/or in addition, the one or more special-purpose computing devices may include digital electronic devices such as one or more application-specific integrated circuits (ASICs) or field programmable gate arrays (FPGAs) that are persistently programmed to perform the techniques. Alternatively, and/or in addition, the one or more special-purpose computing devices may include one or more general purpose hardware processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices and/or any other device that incorporates hard-wired or program logic to implement the techniques.

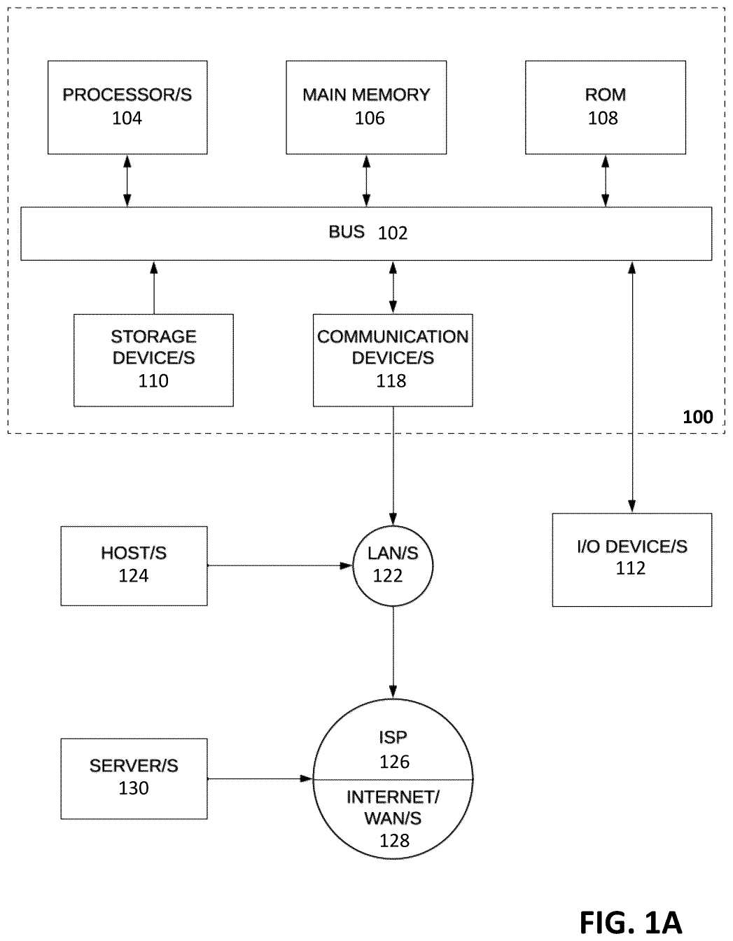

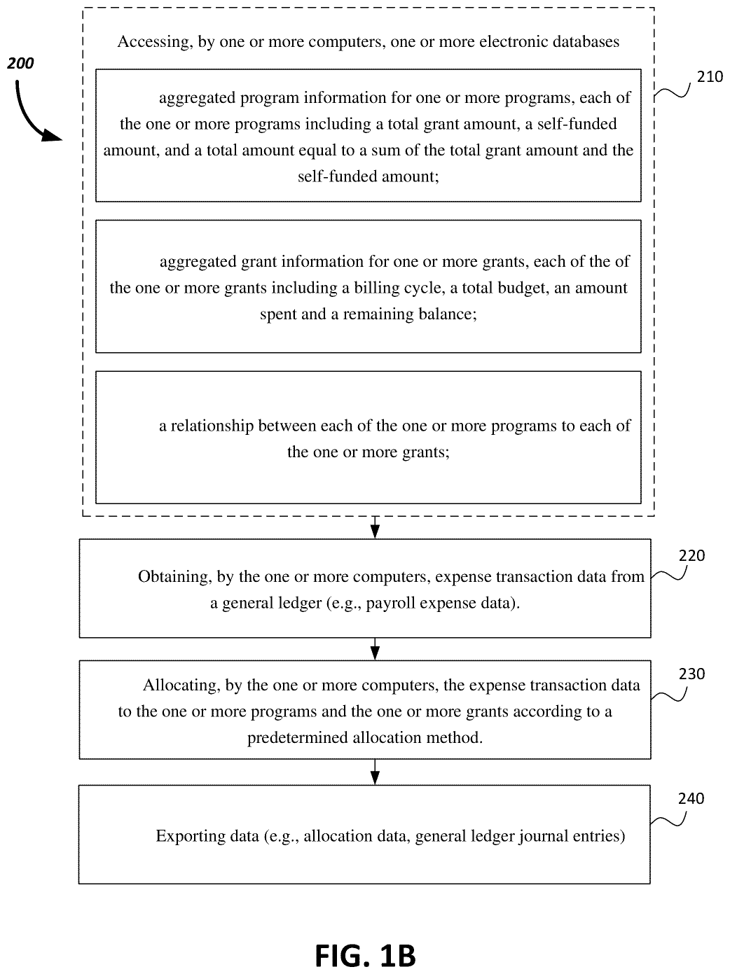

FIG. 1 illustrates a computer system upon which an embodiment may be implemented. Computer system 100 includes a bus 102 or other communication mechanism for communicating information, and one or more hardware processors 104 coupled with bus 102 for processing information, such as basic computer instructions and data. Hardware processor/s 104 may include, for example, one or more general-purpose microprocessors, graphical processing units (GPUs), coprocessors, central processing units (CPUs), and/or other hardware processing units.

Computer system 100 also includes one or more units of main memory 106 coupled to bus 102, such as random-access memory (RAM) or other dynamic storage, for storing information and instructions to be executed by processor/s 104. Main memory 106 may also be used for storing temporary variables or other intermediate information during execution of instructions to be executed by processor/s 104. Such instructions, when stored in non-transitory storage media accessible to processor/s 104, turn computer system 100 into a special-purpose machine that is customized to perform the operations specified in the instructions. In some embodiments, main memory 106 may include dynamic random-access memory (DRAM) (including but not limited to double data rate synchronous dynamic random-access memory (DDR SDRAM), thyristor random-access memory (T-RAM), zero-capacitor (Z-RAM™)) and/or non-volatile random-access memory (NVRAM).

Computer system 100 may further include one or more units of read-only memory (ROM) 108 or other static storage coupled to bus 102 for storing information and instructions for processor/s 104 that are either always static or static in normal operation but reprogrammable. For example, ROM 108 may store firmware for computer system 100. ROM 108 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 110, such as a magnetic disk or optical disk, is provided and coupled to bus 102 for storing information and/or instructions. Storage device/s 110 may include non-volatile storage media such as, for example, read-only memory, optical disks (such as but not limited to compact discs (CDs), digital video discs (DVDs), Blu-ray discs (BDs)), magnetic disks, other magnetic media such as floppy disks and magnetic tape, solid state drives, flash memory, optical disks, one or more forms of non-volatile random access-memory (NVRAM), and/or other non-volatile storage media.

Computer system 100 may be coupled via bus 102 to one or more input/output (I/O) devices 112. For example, I/O device/s 112 may include one or more displays for displaying information to a computer user, such as a cathode ray tube (CRT) display, a Liquid Crystal Display (LCD) display, a Light-Emitting Diode (LED) display, a projector, and/or any other type of display.

I/O device/s 112 may also include one or more input devices, such as an alphanumeric keyboard and/or any other key pad device. The one or more input devices may also include one or more cursor control devices, such as a mouse, a trackball, a touch input device, or cursor direction keys for communicating direction information and command selections to processor 104 and for controlling cursor movement on another I/O device (e.g. a display). This input device typically has at degrees of freedom in two or more axes, (e.g. a first axis x, a second axis y, and optionally one or more additional axes z . . . ), that allows the device to specify positions in a plane. In some embodiments, the one or more I/O device/s 112 may include a device with combined I/O functionality, such as a touch-enabled display.

Other I/O device/s 112 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with processor/s 104 over bus 102.

Computer system 100 may implement the techniques described herein using customized hard-wired logic, one or more ASICs or FPGAs, firmware or program logic which, in combination with the computer system causes or programs, causes computer system 100 to be a special-purpose machine. According to one embodiment, the techniques herein are performed by computer system 100 in response to processor/s 104 executing one or more sequences of one or more instructions contained in main memory 106. Such instructions may be read into main memory 106 from another storage medium, such as one or more storage device/s 110. Execution of the sequences of instructions contained in main memory 106 causes processor/s 104 to perform the process steps described herein. In alternative embodiments, hard-wired circuitry may be used in place of or in combination with software instructions.

Computer system 100 also includes one or more communication interfaces 118 coupled to bus 102. Communication interface/s 118 provide two-way data communication over one or more physical or wireless network links 120 that are connected to a local network 122 and/or a wide area network (WAN), such as the Internet. For example, communication interface/s 118 may include an integrated services digital network (ISDN) card, cable modem, satellite modem, or a modem to provide a data communication connection to a corresponding type of telephone line. Alternatively and/or in addition, communication interface/s 118 may include one or more of: a local area network (LAN) device that provides a data communication connection to a compatible local network 122; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network access a wide area network (WAN, such as the Internet 128); and other networking devices that establish a communication channel between computer system 100 and one or more LANs 122 and/or WANs.

Network link/s 120 typically provides data communication through one or more networks to other data devices. For example, network link/s 120 may provide a connection through one or more local area networks 122 (LANs) to one or more host computers 124 or to data equipment operated by an Internet Service Provider (ISP) 126. ISP 126 in turn provides connectivity to one or more wide area networks 128, such as the Internet. LAN/s 122 and WAN/s 128 both use electrical, electromagnetic or optical signals that carry digital data streams. The signals through the various networks and the signals on network link/s 120 and through communication interface/s 118 are example forms of transmission media, or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire and fiber optics, including traces and/or other physical electrically conductive components that comprise bus 102. Transmission media can also take the form of acoustic or light waves, such as those generated during radio-wave and infra-red data communications.

Various forms of media may be involved in carrying one or more sequences of one or more instructions to processor 104 for execution. For example, the instructions may initially be carried on a magnetic disk or solid state drive of a remote computer. The remote computer can load the instructions into its main memory 106 and send the instructions over a telecommunications line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 can send messages and receive data, including program code, through the network(s), network link 120 and communication interface 118. In the Internet example, one or more servers 130 might transmit signals corresponding to data or instructions requested for an application program executed by the computer system 100 through the Internet 128, ISP 126, local network 122 and a communication interface 118. The received signals may include instructions and/or information for execution and/or processing by processor/s 104. Processor/s 104 may execute and/or process the instructions and/or information upon receiving the signals by accessing main memory 106, or at a later time by storing them and then accessing them from storage device/s 110.

### System Features

The systems described above may be used to implement a grant billing system capable of providing several features to a client. In some embodiments, a grant billing system may manage one or more grant budget(s). It may also identify the underutilization of one or more grant budgets and provide visual and/or audible alerts, or communication so corrective action can be taken such as a budget modification request, staff reassignments. The billing system may have the ability to manually override an allocation. It may import client transactions from any general ledger system. It may import client payroll registers from any third-party payroll vendor. It may create automated downloads that can be exported and used by clients. The billing system may also retrieve support documents from a client folder as support of the invoice. The billing system may also create automated downloads that can be exported and used by clients.

### Client List

In some embodiments, a grant billing system client list may include any or more of the following variables: both independent domestic and foreign not-for-profit organizations and any affiliates, and/or a listing of third-party services providers that offer billing services to not-for-profit organizations. In some examples, a client type structure may include (1) a parent company or companies that can be linked to multiple affiliated companies with limited access, (2) one or more affiliated companies linked to a parent company with complete access within the affiliate, (3) a stand-alone company or companies that are not linked to any parent or affiliate, with complete access only within that particular company, (4) a professional service provider company that is linked to multiple clients with a portfolio, with unlimited access to clients in their portfolio (e.g., an accountant), and/or (5) a client company linked to one professional service provider company, with complete access only within their company.

### Custom Data Tables

In some embodiments, the grant billing system one or more client custom data tables. These tables may be populated by importing a system template (e.g., CSV File) or by manually adding in system setup screens. The data tables may include, but are not limited to, a master chart of accounts, a listing of departments (e.g., programs and services), a listing of grants, organizational job functions, program budgets, grant budgets, payroll register, general ledger transactions, expense allocation transactions that may be, for example, system generated, grant remaining expense amount balances, grant/program monthly periodic grant billing percentage, and a document management system.

### Expense Allocation

In some embodiments, the grant billing system may handle expense allocation calculations for one or more of the following expense type categories: employee-related expenses, direct expenses, and indirect expenses. Employee-related expenses may include employee compensation types (e.g., full-time, part-time, hourly rate, per diem, or other), compensation rate, employee payroll related benefits (i.e., fringe benefits) including insurance coverages (e.g., health, dental, vision and prescription plans, supplemental life and disability, malpractice, etc.), retirement plans (e.g., 403b matching, 403 pension contributions, corporate pension plans, and other applicable plans). Direct expenses may include all expenses particularly-incurred for any program. Indirect expenses may include, for example, all expenses from a designated support department (e.g., executive administration, human resources, accounting and finance, facilities management, development, legal, etc.).

The billing system may include four types of expense allocation methods, and a user may select the desired allocation method amongst them. These may include a standard accelerated method, a weighted accelerated method, a maximized weighted accelerated method, and a straight-line proration. The standard accelerated method may use a pro-rated amount of the remaining available budget for each grant at the expense type category across the total of all grants that fund the specific program to calculate the Grant Program Monthly Periodic Grant Billing Percentage. The weighted accelerated method may use the same variables of the standard accelerated method along with additional logic that uses 12 months as a weighting basis and the number of months remaining in a grant contract to calculate the Grant Program Monthly Periodic Grant Billing Percentage. The maximized weighted accelerated method may use the same variables of the weighted accelerated method along with additional logic that uses a Factor (determined by the Client) to calculate the Grant/Program Monthly Periodic Grant Billing Percentage. The straight-line proration may include a predetermined amount per month from each grant.

As shown in FIG. 1B, in some examples a method 200 for allocating funds among a plurality of program and one or more grants, comprising an accessing step 210, the accessing step using one or more computers to access one or more electronic databases. The databases may include (1) aggregated program information for one or more programs, each of the one or more programs including a total grant amount, a self-funded amount, and a total amount equal to a sum of the total grant amount and the self-funded amount, (2) aggregated grant information for one or more grants, each of the of the one or more grants including a billing cycle, a total budget, an amount spent and a remaining balance, and (3) a relationship between each of the one or more programs to each of the one or more grants. In step 220, the method may obtain, by the one or more computers, expense transaction data from a general ledger. In step 230, the method may allocate, by the one or more computers, the expense transaction data to the one or more programs and the one or more grants according to a predetermined allocation method. Any subset of the data (e.g., allocation data, general ledger journal entries, etc.) may be exported in step 240. The data (e.g., allocation data, calculated allocations, remaining budgets, etc.) may be save into a database for future access.

In some embodiments, a grant billing system may employ custom business logic to allocate expenses. Specifically, the grant billing system may use various data points from the client custom data tables to make the calculations for the selected expense allocation method as noted above. In some examples, a method includes in aggregate and keys off certain attribute and data fields to determine the amount that can be and should be allocated to maximize the amount of the grant. In some examples, the method includes compiling in aggregate all unallocated expense records at the Expense Type Category within a Program. In some examples, the method includes compiling in aggregate all Remaining Available Balance at the Expense Type Category, for all Grants that fund a specified Program. In some examples, the method includes utilizing the not-for-profit selected expense allocation method and calculates the Grant/Program Monthly Periodic Grant Billing Percentage at the Expense Type Category (this is a stored calculation). In some examples, the method includes utilizing the not-for-profit custom factor (if Maximized Weighted Accelerated Method is selected). The Grant/Program Monthly Periodic Grant Billing may be is assigned to each member transaction of an Aggregated Expense Type Category and used to Calculate Transactional Expense Allocation Amount which created a new transaction record. In some examples, the method includes applying the New Transaction Record used as a detailed record for Grant Billing System and applied against the Grant Available Balance.

The billing system may further include a grant budget modification functionality. In this example, the grant billing system has a process for creating an expense modification in any grant by treating it in an accounting period of its own. This allows the system to update the Grant Remaining Expense Amount Balances after a previous billing period is finalized and before calculating the upcoming billing period. This solves the potential problem of not having enough expenses allocated to a grant, which runs the risk of leaving unspent funds at the end of the contract.

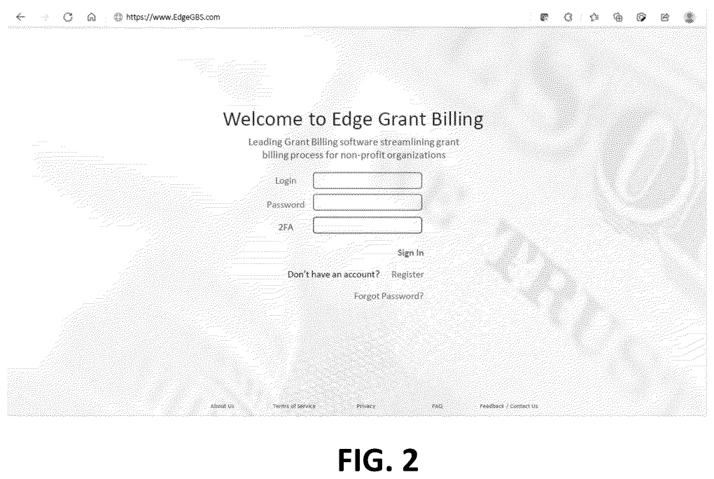

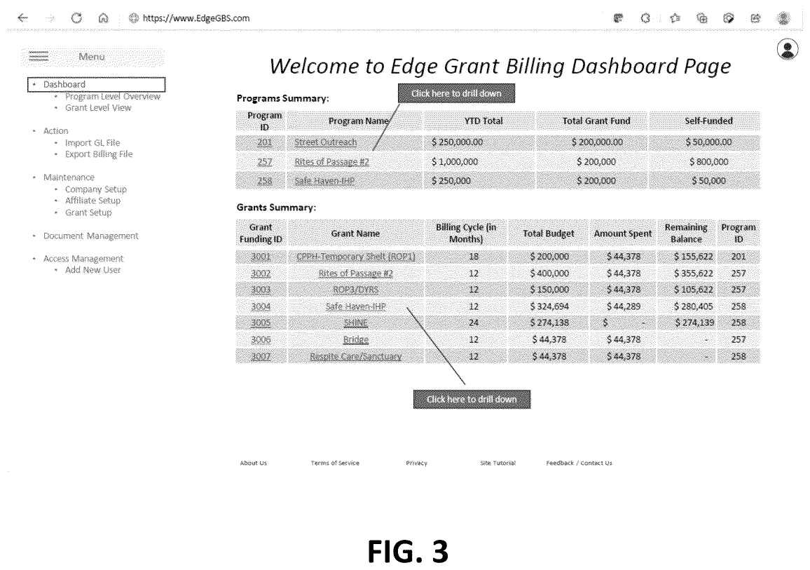

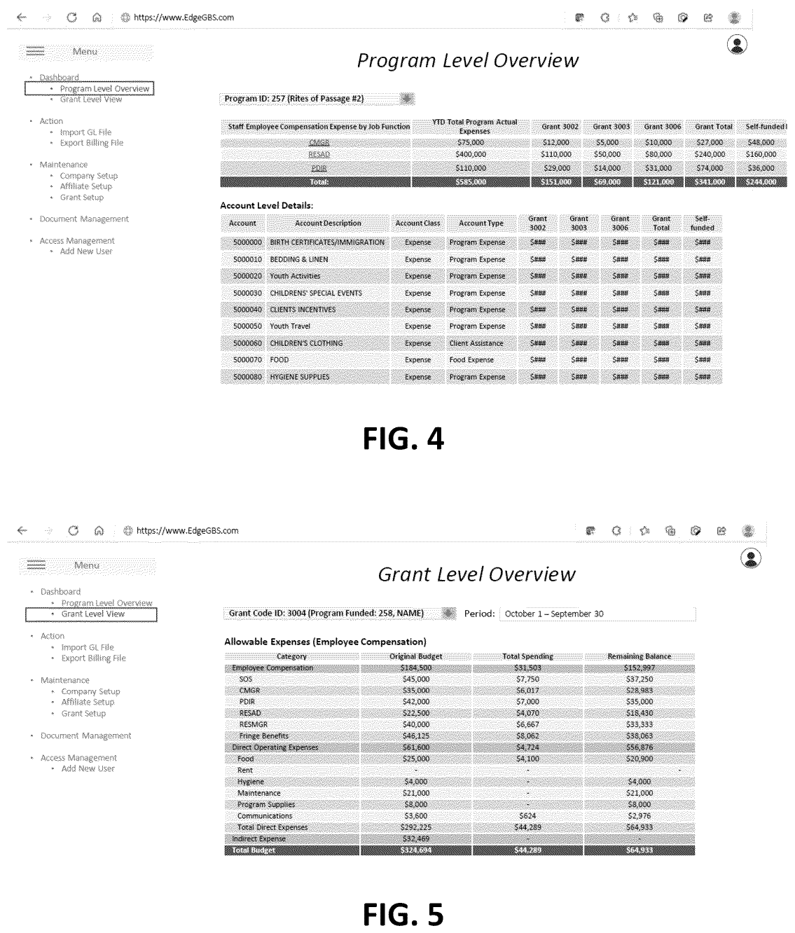

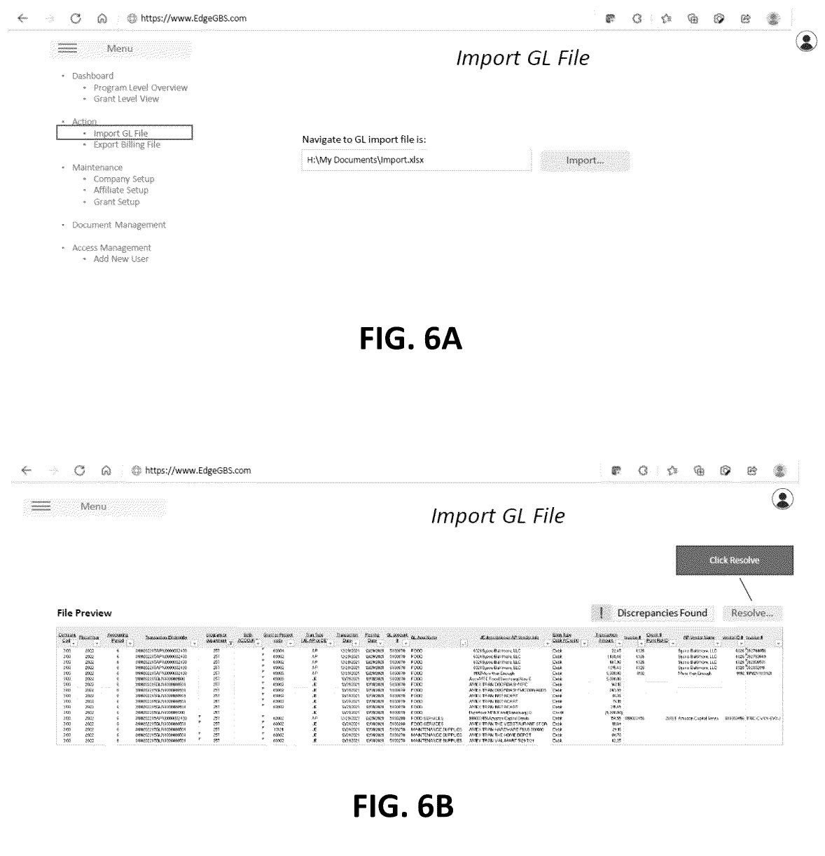

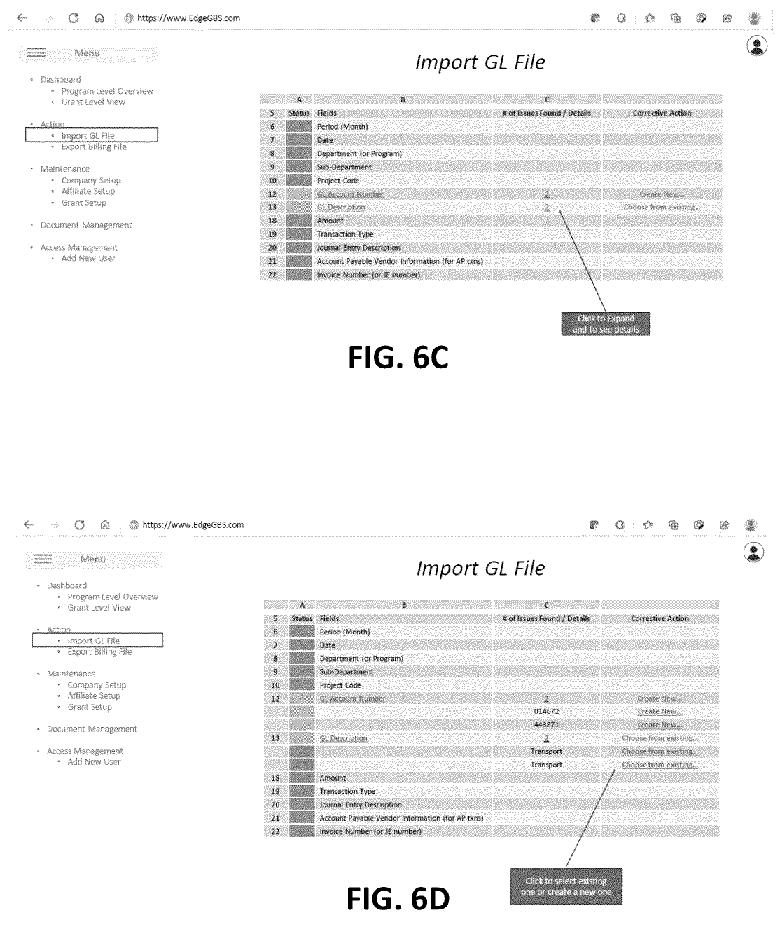

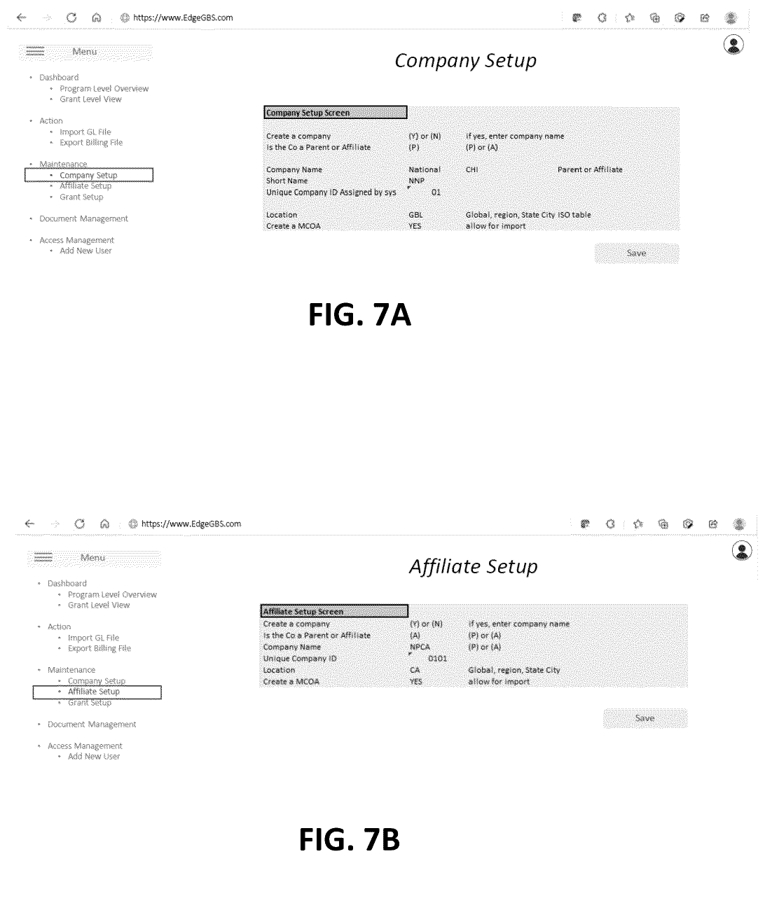

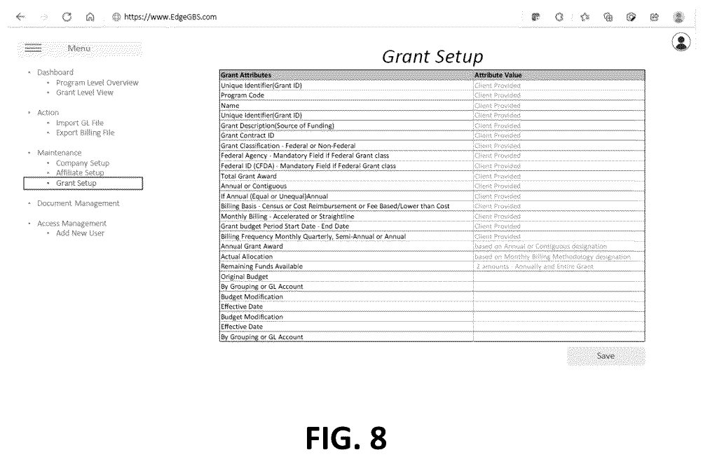

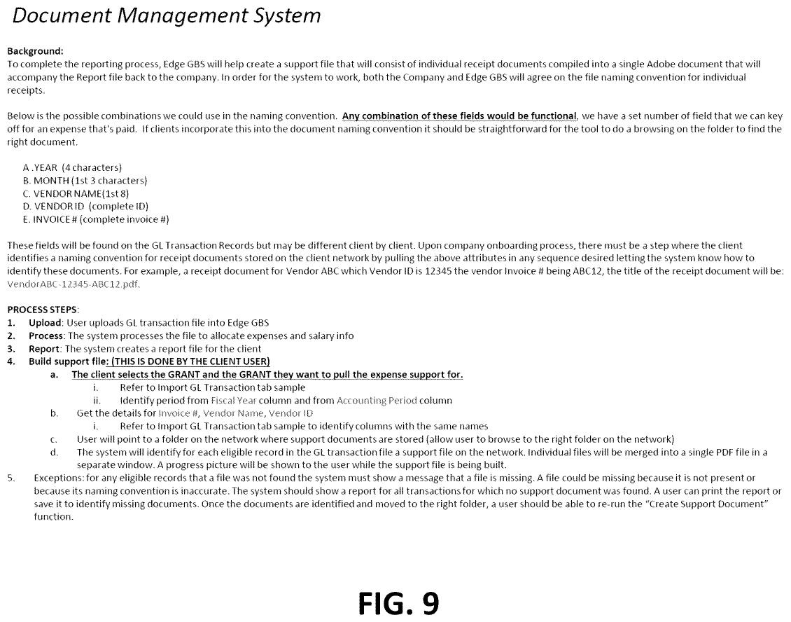

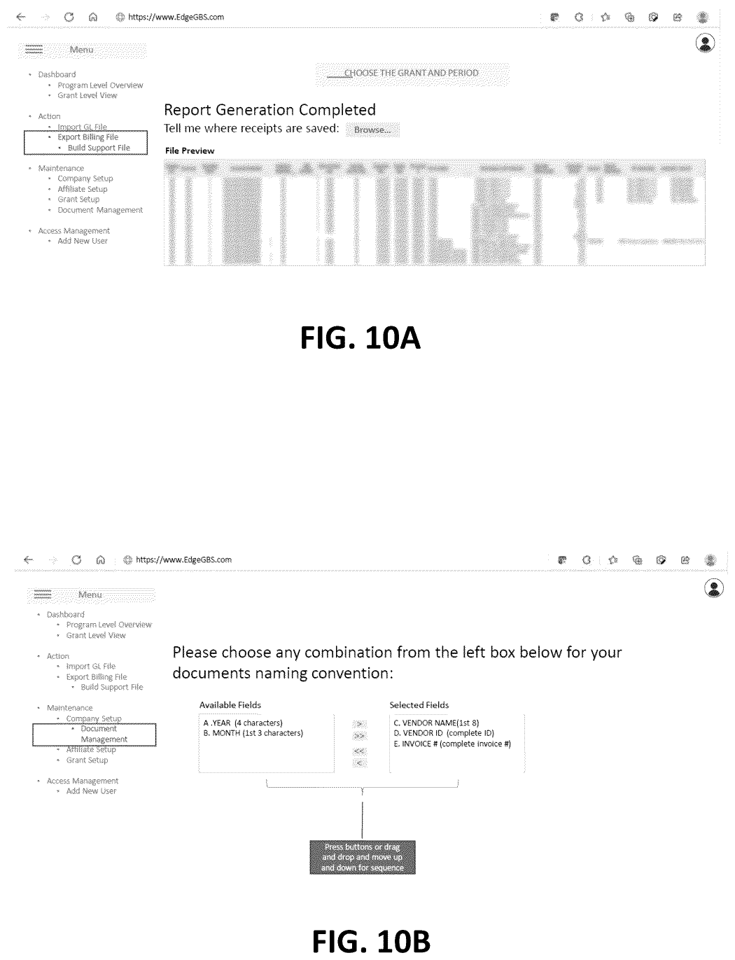

FIGS. 2-10 illustrate several screenshots from an exemplary grant billing system to shows initial logging into the platform, a billing system dashboard view, a billing system program level overview, a billing system grant level overview, the steps of importing data of a general ledger file, a billing system company setup, a billing system affiliate setup, a billing system grant setup, a document management setup, and report generation and reporting naming conventions. These screenshots are provided to shown one example of the discloses method but are not to be construed as limiting the scope of the disclosure.

### Other Aspects of Disclosure

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for allocating funds among a plurality of program and one or more grants, comprising:
(A) accessing, by one or more computers, one or more electronic databases comprising:
(1) aggregated program information for one or more programs, each of the one or more programs including a total grant amount, a self-funded amount, and a total amount equal to a sum of the total grant amount and the self-funded amount;
(2) aggregated grant information for one or more grants, each of the of the one or more grants including a billing cycle, a total budget, an amount spent and a remaining balance;
(3) a relationship between each of the one or more programs to each of the one or more grants;
(B) obtaining, by the one or more computers, expense transaction data from a general ledger; and
(C) allocating, by the one or more computers, the expense transaction data to the one or more programs and the one or more grants according to a predetermined allocation method.

2. The method of claim 1, wherein the expense transaction data includes employee-related expenses.

3. The method of claim 2, wherein the employee-related expenses include employee compensation rates and compensation types.

4. The method of claim 2, wherein the employee-related expenses include payroll benefits.

5. The method of claim 2, wherein the employee-related expenses include retirement plan expenses.

6. The method of claim 1, wherein the expense transaction data includes direct expenses.

7. The method of claim 1, wherein the expense transaction data includes indirect expenses.

8. The method of claim 7, wherein the indirect expenses include designated support department expenses.

9. The method of claim 1, wherein the predetermined allocation method includes at least one of a standard accelerated method, a weighted accelerated method and a maximized weighted accelerated method.

10. The method of claim 9, wherein the standard accelerated method comprises using a pro-rated amount of a remaining balance of each of the one or more grants across all grants that fund a specific one of the one or more programs to calculate a grant program monthly periodic grant billing percentage.

11. The method of claim 9, wherein the weighted accelerated method comprises using (1) a pro-rated amount of a remaining balance of each of the one or more grants across all grants that fund a specific one of the one or more programs, and (2) a period of twelve months as a weighted basis and a number of remaining months remaining in each of the one or more grants to calculate a grant program monthly periodic grant billing percentage.

12. The method of claim 9, wherein the maximized weighted accelerated method comprises using (1) a pro-rated amount of a remaining balance of each of the one or more grants across all grants that fund a specific one of the one or more programs, and (2) a client-provided factor to calculate a grant program monthly periodic grant billing percentage.
